(19) United States
(12) Patent Application Publication
(10) Pub. No.: US 2011/0155558 A1
(43) Pub. Date: Jun. 30, 2011

(54) PROCESS FOR REDUCING NAPHTHENIC ACIDITY & SIMULTANEOUS INCREASE OF API GRAVITY OF HEAVY OILS

(75) Inventors: Mauri Jose Baldini Cardoso, Rio de Janeiro (BR); Elizabeth Marques Moreira, Rio de Janeiro (BR); Mauricio Souza de Alencar, Rio de Janeiro (BR); Claudio Roberto Ribeiro da Silva, Rio de Janeiro (BR)

(73) Assignee: PETROLEO BRASILEIRO S.A.-PETROBRAS, Rio de Janeiro (BR)

(21) Appl. No.: 12/981,232

(22) Filed: Dec. 29, 2010

(30) Foreign Application Priority Data
Dec. 30, 2009 (BR) PI 0905232-1

(51) Int. Cl. C10G 31/00; B01J 19/12; B82Y 30/00

(52) U.S. Cl. 204/157.6; 977/700

(57) ABSTRACT

A process for API GRAVITY enrichment and the reduction of naphthenic acidity of petroleum, heavy petroleum, extra-heavy oil and oil mixtures and their fractions in the presence of microwave-absorbing materials, preferentially those which absorb radiation in localized sites forming nanoreactors, pure or in mixtures such as spent hydrotreatment catalysts. The process is characterized by causing an increase in the API GRAVITY of the petroleum or its mixtures, performing the cracking of the heavier fractions present in the petroleum and reducing the concentration of naphthenic acids present in the processed petroleum. This process is also characterized by operating at a relatively low temperature and pressure with an operating range that enables a simplified union of the microwave source with a petroleum enrichment industrial reactor.

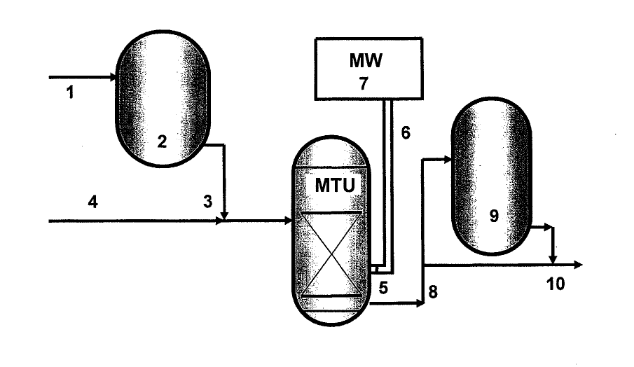

This application claims foreign priority to Brazilian Patent Application PI 0905232-1, filed Dec. 30, 2009, the contents of which are incorporated herein by reference.

### FIELD OF INVENTION

This invention applies to the field of application of API GRAVITY enrichment processes and the reduction of naphthenic acidity of crude oil, heavy crude oil and oil mixtures and their fractions, preferentially relating to processes which involve the treatment of these loads in the presence of microwave-absorbing (MW) materials, more preferentially still those which absorb radiation in localized sites forming nanoreactors, in particular, among the materials which have already been used in refinery units such as spent hydrotreatment catalysts.

In this process, the active catalyst sites added to the load under the synergic action of the irradiation of electromagnetic waves are capable of:
a) Causing the increase of the API GRAVITY of crude oil or petroleum mixtures;
b) Causing the cracking of heavier fractions present in crude oil, resulting in the narrowing of the distillation curve and reducing the concentration of the naphthenic acids of the processed petroleum.

### FUNDAMENTALS OF THE INVENTION

Irradiation of materials using microwaves (MW) is used in a number of industrial applications as an alternative source of the enrichment of specific systems. Various articles and patents claim successful use of microwave technologies (MW) applied to the processing of petroleum and to accelerate chemical processes which require heating.

Microwave (MW) are non-ionizing electromagnetic radiations with a wavelength of 1 meter (m) to 1 millimeter (mm) corresponding to a frequency interval of 300 MHz to 300 GHz. In the heating mechanism using MW, the electromagnetic energy absorbed by the material is transformed into thermal energy. The frequencies of 915 MHz, 2450 MHz, 5800 MHz and 22125 MHz were defined in an international agreement for use in equipment for medical, scientific, industrial and domestic applications, including in this the domestic microwave.

Frequencies of 915 MHz and 2450 MHz are the most employed in industrial applications. In domestic ovens the frequency of 2450 MHz is generally used, with a wavelength of 12 cm and a power of the order of 1000 W. There are various forms of microwave generators, continuous and pulsed, and models with the power of tens of kW up to a MW.

The nucleus of a device supplied with a source for emitting electromagnetic energy in the microwave range, such as, for example, a reactor aided by microwaves, is a specific valve capable of generating this type of electromagnetic radiation.

This emitter of electromagnetic radiation consists, for example, of a device in a vacuum, which converts low frequency electrical energy in an electromagnetic field which oscillates at a high frequency (microwaves).

Radiation within the range of microwaves for industrial applications may be generated by a range of devices, such as for example: magnetrons, power grid tubes, klystrons, klystrodes, cross-field amplifiers, traveling wave tubes (TWT) and gyrotrons. These devices are built according to the size of the application, to operate in a wide range of radiation powers and frequencies.

In the case of a magnetron-type device, a difference in constant potential is applied between the poles: an anode, which is a hollow circular cylinder, with characteristic cavities in its periphery, and a cathode.

The electrons are accelerated from the cathode to the anode but the presence of a strong magnetic field between the two poles produced by a permanent magnet or electromagnet causes the electrons to adopt a curved trajectory and follow a spiraling direction, producing a radiofrequency (RF). An antenna conducts the electromagnetic radiation present in the cavities around the anode to the exterior of the magnetron. The waves produced are conducted by a wave guide to the cavity in which the material to be irradiated is contained. The metallic walls of the interior of the device absorb little energy and most of the energy is reflected until it is absorbed by the material to be irradiated.

In a MW oven or reactor heating is selective due to the specific characteristic properties of the materials to be processed, in particular the microwave absorbent material.

Materials react in a different way to the energy of microwaves and can be classified as conductors, isolators or dielectric with a high loss factor. The action of microwaves on the reaction medium may occur due to its interaction with the dipoles of the polar molecules or free ions of reagent liquids and gases as well as their interaction with solid, dielectric materials or not, or even specifically with their active sites, added to the reaction medium.

Electricity conducing materials (metals, for example) reflect almost all microwaves, heating up primarily due to ohm losses, as superficial and with reduced intensity as their conductivity increases.

On the other hand, insulating materials, also known as dielectrics, may be transparent or opaque to microwaves according to their dielectric loss factor, also known as the imaginary part of electric permittivity, referred to hereinafter solely as loss factor, a scale which results from the frequency of electromagnetic radiation and the temperature of the material.

Dielectric materials with a low loss factor are generally transparent to microwaves and little susceptible to heating via interaction with this electromagnetic radiation.

However, dielectric materials with a high loss factor interact with microwaves and convert the electromagnetic energy into thermal energy, heating up with the absorption and concomitant attenuation of the microwaves as these propagate in their interior. This process is known as dielectric heating and may act differently on loads of hydrocarbons, reagents and catalysts, even when in direct contact between these and homogenously mixed, different to heating via conduction or convection, used in conventional process such as combustion or the use of electrical resistances as heat sources.

A description of a heating process using microwaves involves a number of physical-chemical concepts such as temperature, calorific capacity, chemical bonding, molecular structure, dipole moment, induced polarization, dielectric constant or relative permittivity, real or imaginary complex permittivity, conductivity, Joule effect, ohm losses, etc.

The depth of the penetration of the material is a function of the frequency and dielectric characteristics of the material, and defined as the distance covered by the field from the surface of the metal so its intensity drops to 1/fraction of its initial value.

In general, the higher the actual conductivity of the material, the lower the depth of penetration. In the same way, the higher the frequency of the MW, the lower the penetration depth.

From the classical point of view, the heating of a material due to MW radiation results from the interaction of the electromagnetic wave with the electric dipole of the molecule or with electrically charged molecules or atoms or free ions. The heating of the sample may be understood as analogous to that which occurs with molecules when subjected to the action of an electric field.

When the field is applied, the molecules which have electric dipole momentum tend to align themselves with the field. When the field which caused the alignment of the molecular dipoles is removed, a dielectric relaxation occurs, in other words, the molecules tend to return to their previous unaligned state, dissipating the energy absorbed in the form of heat. In the case of free ions, the presence of the electric field causes their acceleration and this kinetic energy transforms them into thermal as they crash into the other particles.

The most important dielectric particles to be included in the processing of materials using MW are: the loss factor (∈″), actual electric conductivity (σ), the tangent of loss (δ) and the relative complex dielectric permittivity (∈).

The magnetic field of radiation also interacts with the materials inducing specific and localized heating.

There are also specific microwave interaction mechanisms for solid materials: the interfacial polarization or Maxwell-Wagner effect and the effect of conduction. Lots of materials present radiation losses via the conduction mechanism when subjected to microwave irradiation. This effect may even override the dielectric losses.

In the case of solids such as aluminum, the mobility of the electrons in the conduction range is strongly dependent on temperature, resulting in an increase in conductivity. The conduction effect is the primary mechanism of losses which determines the heating under MW of various ceramic materials, metallic, post-metallic and supported metals. All these effects have a major dependency on the frequency of the MW radiation and the temperature at which the material or irradiated system is.

The support of the supported catalysts, generally high area aluminum, has an electrical conductivity considerably lower than the typical values of soft metals. This low conductivity enables greater penetration of the electric fields in the material, generating internal heating preferentially in the absorbent sites via the Joule effect which is also a result of the size of the particle and the properties of the catalyst-support interface.

The active microwave absorbent microscopic sites may offer advantages in industrial applications by configuring micro-reactors or nanoreactors at a high temperature relative to the reaction medium.

The devices which enable this type of heating have been designed to be employed in the reticulation and de-reticulation of rubbers, the treatment of disposed materials, drying of foodstuffs, polymeric materials, timbers and industrialized products (ceramic molds—automotive industry), production of ceramic and refractory artifacts; acceleration of the concrete curing process, chemical syntheses, polymerization of plastics, sterilization of materials, welding of plastics, recycling and recovery of materials, destruction of polymeric tailings, breakage or grinding of rocks, etc.

### Associated Technique

The heating technique using the incidence of radiation within the microwave range in an absorbent material offers the advantage of optimizing the thermal effects in these materials in virtue of their fast, direct and localized heating in the absorbent forms.

In the same way, the effect of this radiation on the absorber material ceases when the source of microwave radiation is removed. Other advantages associated with use of electromagnetic radiation in the microwave range for heating may be highlighted as: energy saving in relation to conventional heating in given processes in which timely and selective heating is desired in materials which have different microwave absorption coefficients; reduced processing time; specific interactions between microwaves, the reagents and active microwave absorbent sites; fast, selective and more uniform heating and minimized wall effects.

Synergic effects which may be obtained when exciting the load and catalysts are of special interest, in particular their active sites with microwaves reacting directly on the reaction medium.

Microwaves can be conducted between the emitting source and the load or mixture to be irradiated via electromagnetic wave guides. These guides may extend for several meters and take sinuous routes with low microwave attenuation. In addition to this, the microwave generating device may be remote from its feeder source.

The growing need to process increasingly heavier oils containing high levels of contaminants, high density and viscosity, high naphthenic acidity and capable of forming oil-water emulsions which are difficult to separate, represents a major challenge for the both the domestic and worldwide refining industries. Several approaches seeking to facilitate the processing of this type of petroleum and obtain derived products of greater aggregate value have been suggested.

Irradiation of materials using electromagnetic energy in the microwave range is used in a number of industrial applications as an alternative way of heating specific systems.

Scientific articles and patents claim the successful use of microwave technologies to accelerate chemical processes which require heating and some other applications in the processing of oils. However, no commercial processes appropriate to the enrichment of petrol employing microwaves are known.

In this invention, crude petroleum materials, petroleum mixtures, fractions resulting from the processing of petroleum, in particular the heavy fractions of petroleum processing are referred to as load.

The technique of processing employing microwave irradiation which has been studied is based on the capacity to cause an interaction or quick selective heating in materials in accordance with their dielectric characteristics, accelerating the kinetics of the chemical reactions and subsequently modifying the properties of these irradiated materials within reduced timeframes.

The petroleum industry has sought to minimize the emission of contaminants via a range of measures such as the use of alternative reagents, processes which present higher conversions and selectivity of the desired products, the use of specific catalysts as well as the recycling of the reagents and catalysts employed in these processes.

Microwave energy is preferentially absorbed by some active catalyst sites but not by the load of hydrocarbons such as, for example, heavy petroleum, or by the catalyst support and tank recipient.

Application of this technology enables the indirect heating of the hydrocarbons of the load, such as, for example, petroleum, fractions and derivatives, by way of the timely heating due to the presence of catalysts which transmit energy in the form of heat via conduction (Cundy, C. “Microwave Techniques in the Synthesis and Modification of Zeolite Catalysts. A Review Collect”, CZECH. CHEM. COMMUN. 63, p. 1699-1723, 1998).

Organic reactions via heterogeneous catalysis have been widely applied within the industrial context. These reactions are carried out successfully because the catalysts supported on porous compounds have an excellent dispersion of the reactive sites, increasing the selectivity and efficiency of traditional reactions.

Initial experiments with the reaction acceleration technique using microwaves were performed with solvents with high coefficients of dielectrics such as dimethyl sulfoxide and dimethyl formamide, causing a superheating during reactions. However, application of this technique has recently been highlighted with studies of reactions on solid supports subject to solvent-free conditions (Varma, R. S. “Solvent-free accelerated organic synthesis using microwaves”, PURE APPL. CHEM., Vol. 73(1), p. 193-198, 2001).

In reactions on solid supports in solvent-free conditions, the organic compounds absorbed in the surfaces of inorganic oxides such as alumina, silica gel, clays and modified supports, absorb this radiation, whilst solid supports do not. The temperature in the inorganic structure during the reaction is relatively low; however, during the process the temperatures at the surface of the support are extremely high. Reactions employing microwave irradiation, in the absence of any solvents, also provide an opportunity to work with open flasks, as a result of the load processed, avoiding the risks of high pressures (Varama, R. S. “Solvent-free accelerated organic synthesis using microwaves”, PURE APPL. CHEM., Vol. 73(1), p. 193-198, 2001).

Application of the methodology and association of electromagnetic energy emitting devices in the processing of hydrocarbon mixtures are usually presented in specialized literature.

The increase in production of heavy oils with a high content of contaminants, such as: sulfur, nitrogen and naphthenic acidity and high total amounts, found in recently discovered petroleum reserves, has been a challenge for petrol companies which will have to process heavier oils and with increasing average acidity levels.

Some oils with production which has not yet begun on a commercial level, have extremely high naphthenic acidity levels (3 mg to 12 mg of KOH/g of oil), incompatible with current specifications of the refining material base of petroleum companies.

Metallurgical adaptation at industrial units includes the replacement of equipment, metallic ducts and is the result of the distribution of naphthenic acids in the fractions of the petroleum. In the same way as a reduced level of API GRAVITY, high acidity content not only produces effects on the processing of petroleum and its fractions but also makes its marketing difficult. In addition to this, the polar character of carboxyls present in naphthenic acids, favors the formation of emulsions, above all in the heaviest oils, reducing the efficiency of the desalting stage of the petroleum. Hence reductions in the acidity and density of oils are major challenges for petroleum industries.

Currently to improve the density of heavy oils and adapt these to the refining industry, these are mixed with others of a lower density or even diluted with lower fractions of petroleum, hence obtaining synthetic oils.

U.S. Pat. No. 6,106,675 specifies a method for the splitting of hydrocarbons with a relatively low molecular weight employing microwaves. However, this application does not envisage the concomitant reduction of naphthenic acidity and much less is it applicable to crude oils.

U.S. Pat. No. 4,749,470 specifies a process for cracking FCC (fluid catalytic cracking) residuals. However, this application does not envisage the concomitant reduction of naphthenic acidity and much less is it applicable to crude oils.

Several patents protect processes to reduce the acidity of petroleum and its derivatives. A first approach would be use of petroleum mixtures with different levels of acidity.

The application of corrosion inhibitors is another solution adopted to get around the problem of naphthenic acidity in oils. Hence, U.S. Pat. No. 5,182,013 specifies that organic polysulfides are effective inhibitors of corrosion from naphthenic acid in distillation units of petroleum refineries.

U.S. Pat. No. 4,647,366 specifies the addition of soluble products in oil such as: alkanethiols and alkylenic polyamides as naphthenic corrosion inhibitors.

Reduction in acidity may also be achieved via the treatment of petroleum with basic solutions of sodium hydroxide or potassium hydroxide as shown in U.S. Pat. No. 4,199,440. However, this approach requires the use of very concentrated basic solutions and a critical point is the formation of emulsions which are hard to separate. Therefore this solution would only be conveniently applicable in low concentrations of the base.

Treatment with a basic detergent based on calcium sulfide or naphthenate containing at least 3% calcium is shown in U.S. Pat. No. 6,054,042 to get around the problem of emulsions.

The oil is treated at temperatures of between 100° C. and 170° C. with stoichiometric proportions of calcium to the acid functionality in the oil of around 0.025:1 to 10:1 moles, or 0.25:10:1, preferably.

U.S. Pat. No. 6,258,258 specifies the use of polymeric amine solutions such as pyridine polyvinyl.

U.S. Pat. No. 4,300,995 specifies the treatment of coal and liquids obtained from coal, in addition to vacuum diesel oils and petroleum residuals which have acidic functions, with basic solutions of quaternary hydroxide ammonia in ethanol or water, such as tetramethylammonium hydroxide.

International Publication WO 01/79286 uses a basic solution with hydroxides of metals of group IA, IIA and ammonia, and application of a transfer agent such as non-basic quaternary salts and polyesters. Whilst in U.S. Pat. No. 6,190,541 bases and/or phosphates with an ethanol to reduce the naphthenic acidity of oils.

In U.S. Pat. No. 6,086,751, naphthenic acidity is reduced by applying a thermal treatment. The oil is initially subjected to a heating process in a pressurized reactor, at pressures of less than 690 kPA and a short time of residence to remove the water and subsequently subjected to temperatures of between 340° C. and 420° C. and reaction times of up to 2 hours.

In U.S. Pat. No. 5,985,137, the naphthenic acidity and sulfur content of the oil are reduced by employing the reaction with oxides of terrous-alkaline metals, forming neutralized compounds and sulfates of terrous-alkaline metals.

The temperature should be higher than 150° C. to remove the carboxylic acids and higher than 200° C. to form sulfate salts.

The pressure applied should maintain the material without vaporizing it. In general, most methods to reduce naphthenic acidity involving thermal treatments with or without the addition of basic solutions require the application of surfactants to get around the problem of emulsions.

Another approach is the absorption of naphthenic acids using absorbent compounds with catalytic properties under temperatures of between 200° C. and 500° C., followed by recovery of the referred absorbent agent.

U.S. Pat. No. 5,389,240 specifies a process for the removal of naphthenic acids from petroleum currents such as kerosene in the presence of a material associated with hydrotalcite known as MOSS (“metal oxide solid solution”) combined with a sweetening process. The appropriate material for the purposes of the patent has to be calcined at around 400° C.

The technology described is applicable to currents containing levels of naphthenic acids at extremely reduced rates, within a range of 0.01 to 0.06, and possibly as high as 0.8.

U.S. Patent No. s is directed to the process of elementary sulfur removal and sulfurous contaminant present in refined petroleum products via contact of the fluid containing mercaptan with an absorbent selected from among: bayerite, brucite and derivatives of hydrotalcite.

Use of a hydrotreatment catalyst to reduce naphthenic acidity is mentioned in U.S. Pat. No. 5,871,636.

The quoted patent refers to use of a catalyst based on transition metal sulfates belonging to groups VIB and VIIIB, supported on alumina. For example, a cobalt and molybdenum catalyst is used supported on a porous alumina matrix with a surface area covering a range of values between 100 m²/g to 300 m²/g which is sulfided prior to use. From this patent, in the absence of hydrogen and at temperatures in excess of 285° C., at most a 53% reduction in naphthenic acidity is achieved in crude oil, initially presenting an acidity and total acidity number, NAT of 4 mg KOH/g. However, the patent does not refer to use of microwaves or spent catalyst.

Brazilian Patent application PI 0202552-3 protects the process for the reduction of naphthenic acidity in petroleum and its derivatives in the presence of an absorbent composed of a catalyst encased in carbon compounds of a high molecular weight.

Brazilian Patent application PI 0304913-2 protects the treatment process for hydrocarbon loads contaminated with a content of naphthenic acids of up to 10 mg KOH/g, involving a thermal treatment in the presence of a hydrotalcite-type absorbent.

U.S. Pat. Nos. 4,582,629 and 4,853,119 propose the use of microwaves to break emulsions though they teach nothing about the removal or reduction of naphthenic acidity.

U.S. Pat. No. 6,454,936 B1 mentions the use of microwaves to separate the emulsion though the aim of the technology set forth therein is not the use of microwaves to reduce the content of naphthenic acids in petroleum but solely the break down and separate the phases of the emulsion.

Despite the advances in the state of the technique of processes to reduce the acidity of the mixtures of hydrocarbons, development of a process which is more efficient is still necessary at a lower cost, adapted to heavy crude oil and without the presence of water.

Brazilian Patent application PI 0503793-0 presents a process for the reduction of acidity in hydrocarbon mixtures via the treatment of currents of hydrocarbons such as crude oils, their fractions and derivatives, under irradiation from microwaves and in the presence of microwave absorbent materials, pure or in mixtures, such as coking fines and spent catalysts which have already been used in fluid catalytic cracking (FCC) or hydrotreatment (HDT) units of a refinery. Though providing good results, one notes that the process presented in PI 0503793-0 may still be perfected with the aim of enriching heavy and extra-heavy oils, also adding value to oils with a low API GRAVITY and high acidity.

It was verified for example that its best field of application is the enrichment of oils in particular those classed as heavy and extra-heavy ones, free of water. Studies carried out in this respect have led to the perfecting of the referred process, obtaining not only the reduction in total acidity but also an expressive reduction in naphthenic acidity.

Existing patents claim the reduction in total acidity present in loads of hydrocarbons without however treating naphthenic acidity, which is the principal component responsible for the corrosiveness of equipment and transfer lines in the petroleum industry.

This invention refers to a process to reduce the naphthenic acidity of heavy and extra-heavy oils with the simultaneous enrichment in quality of the processed petroleum via the increase in their API GRAVITY, attested to by the narrowing of their range of distillation. In addition to this, the process presented herein operates at a relatively low temperature and pressure.

The operating range of the process employing microwaves enables this to be scaled up without the characteristic difficulties of industrial processes subject to high pressure and temperature.

### SUMMARY OF INVENTION

The field of application of this invention is associated with processes to improve the API GRAVITY and reduce the naphthenic acidity of heavy and extra-heavy petroleum as well as mixtures of oils and their fractions.

This process applies preferentially among the processes which involve the treatment of these loads in the presence of microwave absorbent materials, more preferentially those which absorb radiation in localized sites forming nanoreactors. In particular, those which have already been used in a refinery such as spent hydrocarbon catalysts.

Other catalysts, both new and used, which also have microwave absorbent areas or sites, may be used in the process of this invention, with an active phase composed of transition or lanthanide metals in the form of oxides or sulfides.

Of the new formulations apt for use in this process, catalysts which contain nanotubes and nanofibers in their composition are included, with or without the inclusion of other elements of the periodic table with characteristics of microwave absorbent sites.

Reactions occur in the active sites of the catalyst in contact with the load, subject to the synergy of the irradiation of electromagnetic waves and are capable of causing:
1) An increase in the API GRAVITY of crude petroleum or its mixtures as a result of the cracking of the heavier fractions present in crude oil, causing the narrowing of its distillation curve; and
2) Reduction in the naphthenic acid concentration of processed oil.

The process for increasing API GRAVITY and reducing the naphthenic acidity of oils, heavy oils, heavy fractions of oils and their mixtures, comprising the purpose of this invention, seek to partly or totally eliminate the disadvantages of the abovementioned conventional processes employing the treatment of these loads subject to the action of continuous or pulsed microwave irradiation.

This process, which may operate in a batch or continuous regimen, in a fixed, fluidized or slurry bed occurs in the presence of microwave absorbent materials such as, for example, catalysts, spent refinery catalysts, preferentially those materials which absorb radiation in localized sites such as hydro refining catalysts such as those of the alumina supported NiMo or CoMo type, even those which have already been used in hydrotreatment units (HDT) at petroleum refineries.

The energy applied to the reaction system via microwave irradiation is solely that necessary to the heating of the nanoreactors, the area of the active microwave absorbent sites, around which the reactions the object of this process occur.

By way of the appropriate choice of catalysts, whose active sites also behave as selective microwave absorbers, additional gains may be obtained, such as the reduced viscosity of the treated loads and reduced of contaminants such as nitrogen and sulfur present in these heavy oils.

Generally, the petroleum current to be treated, when necessary, is initially desalted in a conventional way. After this stage, the referred current is sent to a microwave treatment unit (MTU) where it is placed in contact in batches or continuously, subject to the irradiation action of electromagnetic waves, such as, for example, microwaves, with a fixed, stirred or slurry bed of a microwave absorbent materials such as, for example, a spent hydrotreatment catalyst.

The pressure of the system may be such that prior to treatment it is equal to or lower than the pressure of the previous unit, the desalter for example, and after treatment the current is at the normal pressure of the following system (such as, for example, atmospheric distillation or storage tank). Finally, the treated load containing a reduced level of total and naphthenic acidity and presenting an increase in API GRAVITY continues along the conventional cycle of storage, transport or refining of petroleum. The microwave absorbent material, in particular the spent hydrotreatment catalyst, may be regenerated and reused in this process.

This oil enrichment unit (OEU) may be located at the petroleum production, storage, transport or refining facility where one intends to reduce the naphthenic acidity of heavy and extra-heavy oils and increase their API GRAVITY such as, for example, described in the text below.

This invention refers to a perfected process which enables the processing of crude loads or mixture of hydrocarbons, using microwaves in the presence of spent hydrocarbon catalysts. This process operates under relatively low temperature and pressure values without the need to add other gases, in a continuous or batch regimen in fixed, fluidized or slurry beds, enriching the crude oil by simultaneously reducing the naphthenic acidity and density, in other words, of the increase in API GRAVITY.

The process of this invention may be operated in at least three different modes, including batches with stirring, continually in flasks with stirring and continually in a fixed or slurry bed.

The process to increase API GRAVITY and reduce the naphthenic acidity of oils and mixtures of oils, which comprises the object of this invention, is better noted from the description which follows below, as an example associated with the drawing which form an integral part of this invention application. It must be clear however that the methods quoted herein are not limited to the invention presented herein.

The petroleum current to be treated, when necessary, is initially desalted in a conventional way. After this stage, the referred current is sent to a microwave treatment unit (MTU).

The temperature may be the temperature at which the current to be treated is set preferentially at between 30° C. and 300° C., after the water is removed or after desalting.

The MTU comprises a conventional reactor which is attached via wave windows and guides to a microwave source. Construction of this unit, which may operate at relatively low pressures, in other words, lower than 2 MPa, and temperatures equal to or lower than 300° C., adopted in this process would not present technical difficulties for an experienced technician in this field.

The system pressure may be such that prior to treatment it is equal to or of the same level as the pressure of the desalting unit, and after treatment, the current is at the normal pressure of the following system, for example, the atmospheric distillation or storage tank systems.

Finally, the treated load containing a reduced level of total or naphthenic acidity and an improved API GRAVITY continues with the conventional petroleum storage, transport or refining cycle. The microwave absorbent material when finally inactivated is disposed of by the method usually employed in conventional hydrotreatment load units.

The drawing illustrates in a schematic fashion the forms of the invention process and refers to a unit for the treatment of oils and mixtures of oils in which the load is placed in contact in batches or semi-continuous contact, stirred in suspension or in a fixed slurry or continuous reactor bed subject to the irradiation action of electromagnetic waves such as for example microwaves containing in addition to the load a microwave absorbent material, such as a spent hydrocarbon catalyst.

### BRIEF DESCRIPTION OF DESIGNS

The drawing illustrates in a schematic fashion an example of the forms of the invention process and refers to units for the treatment of reduced acidity and concomitant increase in API GRAVITY of oils and oil mixtures.

The petroleum treatment process is carried out by employing the following steps, as shown in the drawing:
A current of petroleum or mixtures of hydrocarbons (1) to be treated is sent to a desalter (2). After desalting and water removal, the effluent current (3) is sent to an oil enrichment unit using microwave treatment (OEU). The processing temperature and pressure in the OEU may be of the same level as that of the current (3);
Concomitantly or not to the current (3), another current of petroleum or hydrocarbon mixtures (4) to be treated, and originating from the production area or storage tank or any other pre-treatment unit, is sent directly to the Microwave treatment unit (MTU);
Currents (3) and (4) may be sent together or not to the microwave treatment unit (MTU);
The MTU consists of a conventional batch reactor, stirred or continuous with a fixed or slurry bed, to which a microwave source (7) is attached via a window (5) and a wave guide (6);
An MTU may contain one or more windows (5) to enable the passage of the microwaves, conducted via their respective microwave guides (6), each one fed by a microwave source (7) into the interior of the MTU reactor;
An MTU, the wave guides (6) and microwave source (7) may rely on a range of operating and control devices of the respective units, characteristic and usual in each of these, such as, for example;
The operating pressure and temperature of the MTU unit may be the same as those of the input currents;
The output temperature may be slightly higher than the input due to the energy added to the reaction medium via microwave irradiation;
Finally, at the end of the batch or a given time period in the case of the continuous process, the treated load (8) containing a reduced amount of total and naphthenic acidity and an improved API GRAVITY is sent to storage (9) or continues along the conventional petroleum transport or refining cycle (10); and
The microwave absorbent material, when finally presenting no more activity, is removed from the MTU and disposed of using the method commonly employed at conventional hydrotreatment heavy load units.

### DETAILED DESCRIPTION OF INVENTION

It is to be understood that both the foregoing general description and the following detailed description are exemplary and are intended to provide further explanation of the invention claimed.

This invention applies to the field of application of API GRAVITY enrichment processes and the reduction of naphthenic acidity of oil, heavy oil, extra-heavy oil and oil mixtures and their fractions.

For the purposes of the invention, API GRAVITY enrichment refers to the reduction in density expressed by the increase of API GRAVITY of the oil as a result of treatment using microwaves and the term “naphthenic acids” refers to all naphthenic carboxylic or naphthenic-aromatic acids.

The naphthenic acids removed by the invention process are carboxylic acids of the general RCOOH formula, where R is the naphthenic segment.

Naphthenic acids are predominantly comprised of cycloaliphatic carboxylic acids substituted with alkyl groups. A lesser component, aromatic, olefinic and hydroxyl acids may be present. The molecular weight of the naphthenic acids present in the oils studied, specified using mass spectrometry, varies within a range of between 200 and 700 units of atomic mass.

The process proposed in this invention is based on the synergic effect between the action of the microwaves and the active sites of the catalyst, where local superheating occurs forming nanoreactors. In these active sites of the microwave absorbent material, cracking reactions and the decomposition of organic acids occur, induced or catalyzed by the active sites of the spent catalysts that are heated directly by the action of the microwaves. However, due to the localized heating of the nanoreactors, the energy spent is relatively low and the thermal energy dissipated by the active microwave absorbent sites causes only a slight heating of the reaction medium. Hence, the average temperature of the reaction medium in which the alluded reactions occur is lower than that occurring in a conventional thermal process.

Hence, the proposed process offers an alternative application to spent catalysts such as for example HDT catalysts or other similar ones, currently considered as polluting tailings and of low commercial value.

A way of checking the radiation absorption capacity of the microwaves via a material is to verify its dielectric properties. The dielectric loss factor gives a good indication of how much support material of the catalyst may be penetrated by an electric field and how much of the energy added to the medium may be dissipated in the form of heat at the active microwave absorber sites.

This invention refers to a process to increase the API GRAVITY and reduce the naphthenic acidity of oils employing localized thermal treatment via microwave irradiation, in the presence of electromagnetic energy absorbent materials.

The oils to be preferentially treated are those which have an API GRAVITY lower than 19, usually referred to as heavy oils and those which have an API GRAVITY lower than 13, usually referred to as extra-heavy oils, as well as their mixtures and fractions. These oils generally have a content of total acids measured as NAT of between 1 mg/KOH/g and 12 mg/KOH/g of oil, preferably with NAT comprising a range of values of between 1.5 mg/KOH/g and 10 mg/KOH/g of oil.

Some of the microwave absorbent materials which may be applied to this process are coking fines, catalysts of spent FCC's, the catalysts of spent hydrotreatments, nanostructured materials such as nanofibers and nanotubes. Of the microwave absorber materials, those which absorb radiation at localized sites were preferably selected, such as hydro-refining catalysts. In this case, NiMo and CoMo alumina supported catalysts in particular were selected, characteristic due to their morphology, activity, selectivity and interaction with microwave energy.

Also, of these materials with catalytic sites and microwave absorbent, preferred examples include those which have already been used in HDT units of refineries, in particular spent HDT catalysts, previously sulfides, stored after an inventory replacement, with care taken to keep these protected from the atmosphere since the type and level of sulfiding of the catalyst significantly influences the rate of heating, final acidity and increase in API GRAVITY of the treated load.

The term spent catalyst is referred to herein to mean a catalyst or mixture of catalysts that have already been used in units at a refinery and disposed of at the end of their life cycle.

Other catalysts, new or used, which also have microwave absorbent areas or sites, may be used in this process. In particular, traditional catalysts in the petroleum industry with an active phase composed of transition or lanthanide metals in the form of oxides or sulfides. Of the new formulations apt for use in this process, catalysts which contain nanotubes and nanofibers in their composition are included, with or without the inclusion of other elements of the periodic table with characteristics of active microwave absorbent sites.

The referred treatment in a reactor containing a solid absorbent leads to a reduction of up to 93% of the naphthenic acidity number (NAN) value of a petroleum from the Campos Basin (BC petroleum) when processed in the presence of spent hydrotreatment catalysts (HDT), subject to microwave (MW) irradiation. These results were obtained in reaction medium temperatures of around 260° C. whilst under conventional heating, reduced acidity only begins to be observed above 300° C.

The referred treatment via microwaves in a reactor in the presence of spent catalyst also causes a narrowing of the distillation range of oils processed using MW. The reduction in the heavy fractions present in crude oil processed using MW reflects the increase in its API GRAVITY and subsequently its improved quality.

The basic scheme proposed herein consists of inserting one or more units for the general treatment of heavy and extra-heavy crude oil, or mixture of hydrocarbons subject to the action of microwaves (MW) at least in one of the phases of the process described below.

The phases of the process include:
1) Desalting, water removal or pre-heating of crude oil or mixtures of oils with high values of total acidity at temperatures which vary in a range of characteristic values, ranging from 25° C. to 300° C.;
2) Placing the referred crude oil or mixture of oils into contact in batches or continually with a fixed or slurry bed subject to the action of microwave energy of a wavelength of a range of 1 m to 1 mm, corresponding to a frequency interval of 300 MHz to 300 GHz. The bed is comprised of a microwave absorbent material, such as for example, a spent catalyst from a hydrotreatment unit. The load input temperature ranges between 25° C. and 300° C., preferably at a temperature ranging between 30° C. and 260° C. The pressure of the system is not critical and may be adjusted in such a way that prior to treatment it is equal to or lower than the pressure of the previous unit such as a desalter and after treatment the current is at the normal pressure of the following system, such as for example an atmospheric distillation unit or storage tank;
3) Continuous removal of the crude oil or mixture of irradiated oils or at the end of the batch, presenting a reduced amount of TAN and NAN and density, for storage in a tank and subsequent sale or to be sent to the conventional units of the petroleum refining process;
4) The microwave absorbent material contained in the MW unit when finally inactivated is disposed of using the method usually employed at conventional heavy load hydrotreatment units.

Spatial velocity ranges from between 0.10 h⁻¹ and 10 h⁻¹, preferably within a range of between 0.2 h⁻¹ and 6 h⁻¹.

The microwave absorbent material used in this invention may be, for example, metallic oxides, sulfates, coking fines tailings; compounds containing nanostructured materials such as nanofibers and nanotubes; catalysts or mixtures of catalysts disposed of at fluid catalytic cracking units; catalysts or mixtures of catalysts disposed of at hydrotreatment units, comprised of transition metals (such as Co, Mo, Ni, etc.), supported on refractory oxides which may be chosen from among alumina, silica, titanium, zirconium and/or mixtures, and others, in which the material which supported the active phase of the absorbent material may be preferably transparent to microwaves. In the case of spent catalysts, these may have suffered a phase of intermediary rectification or not in the presence of an inert gas.

The technology proposed herein has the added advantage of reusing the spent materials, delaying their disposal and treatment as tailings.

An advantage of this process is that it operates at relatively low temperature and pressure. The operating phase of the process enables it to be scaled up without the characteristics difficulties of hooking up a microwave source to industrial processes which used high pressure and temperature.

The radiation is normally conducted to the reactor guided in wave guide ducts connected to the reactor via windows. These windows must be appropriate for the radiation to pass through but must also withstand the pressure conditions which vary from atmospheric to 50 bar and temperatures of the reaction medium which range from 25° C. to 300° C., characteristic of the process.

Construction of microwave transparent windows capable of withstanding relatively low pressure and temperature is within the skill of those experienced in the field.

This oil enrichment unit employing microwave (MW) treatment may be located in petroleum production, storage, transport or refining facilities wherever one wishes to reduce the acidity of oils and increase their API GRAVITY.

Installation of an oil enrichment unit using microwave treatment (MTU) housed on an oil transport vessel has the added advantage of making use of the time the oil spends onboard the vessel in order to process its acidity and API GRAVITY enrichment.

The process to increase API GRAVITY and reduce the naphthenic acidity of heavy, extra-heavy oils and mixtures of oils, which comprises the object of this invention, is further observed in the exemplary description set out below in conjunction with the drawing.

The drawing illustrates in a schematic fashion the forms of the process of the invention and refers to the reduced acidity and increase in API GRAVITY of oils and mixtures at production, transport and refining units. At a production unit, the petroleum current to be treated is initially desalted in a conventional way to reduce the content of water and salts. Following this, the pre-treated current is sent at the desalting temperature to the microwave treatment (MW) oil enrichment unit.

The MTU consists of a modified conventional reactor in which the internal materials must be microwave transparent and at the same time resistant to the pressures and temperatures used during processing. In this reactor, a microwave source is attached via windows and wave guides.

Construction of this unit to operate at the relatively low pressures and temperatures adopted in this process is of no great difficulty to a technician experienced in the field. Processing of the MTU load is not dependent on pressure, which may be adjusted to that of the unit which precedes it.

Finally, the effluent current from the MTU, containing a reduced amount of total and naphthenic acidity and an enriched API GRAVITY continues to the conventional petroleum storage, transport or refining process.

The drawing illustrates in a schematic fashion the forms of the process of the invention and refers to a petroleum and petroleum mixture treatment unit where the load is placed in contact in batches or semi-continuously, stirred or in a fixed bed slurry or continuous reactor, subject to the irradiation action of electromagnetic waves such as for example, microwaves in an stirred reactor in suspension or in slurry containing in addition to the load a microwave absorbent material such as for example a spent hydrotreatment catalyst.

Table 1 shows the results of Total Acidity Number (TAN) and Naphthenic Acidity Number (NAN) of the petroleum samples from the Campos Basin, initially presenting TAN equal to 3.2 mg of KOH/g of oil and NAN equal to 1.8 mg KOH/g of oil, and the results after MW irradiation in three different reaction conditions. One notes a strong reduction in total and naphthenic acidity of the Campos Basin petroleum (BC). Of the tests, the best result obtained was that in which the sample was irradiated with MW for 5 hours at a temperature of 260° C. (BCT-29 petroleum). The “T” in “BCT” refers to a treated Brazilian Campos petroleum, and the number 20, 29 and 50 simply refer to the number of the test done.

TABLE 1

| ACIDITY | TAN* | NAN* |
|---|---|---|
| BC petroleum | 3.2 | 1.83 |
| BCT-20 petroleum | 1.3 | 0.20 |
| BCT-29 petroleum | 0.6 | 0.12 |
| BCT-50 petroleum | 0.8 | 0.64 |

Table 2 also presents for the purposes of comparison, the results of treatment of the same petrol using conventional heating instead of microwaves, with all other operating conditions maintained constant. All these tests were carried out in batches and on a laboratory scale in accordance with the processing presented in a schematic fashion in the drawing.

TABLE 2

| | Energy | Temperature | Time | Δ TAN | Δ NAN |
|---|---|---|---|---|---|
| TEST | Source | (° C.) | Minutes | (%) | (%) |
| T32 | Conventional | 269 | 330 | 68.8 | 68.3 |
| T40 | Conventional | 251 | 60 | 12.5 | Zero |
| T52 | Conventional | 271 | 60 | 12.5 | Zero |
| T20 | Microwave | 267 | 20 | 59.4 | 88.9 |
| T29 | Microwave | 271 | 330 | 81.3 | 93.3 |
| T41 | Microwave | 275 | 60 | 21.9 | — |
| T44 | Microwave | 280 | 60 | 62.5 | 44.4 |
| T48 | Microwave | 300 | 60 | 68.8 | 67.2 |
| T50 | Microwave | 300 | 60 | 75.5 | 64.4 |

Table 3 demonstrates the results for the distillation ranges obtained via the simulated distillation of petroleum from the Campos Basin (prior to microwave treatment) and samples of petroleum processed after microwave irradiation tests, on a laboratory scale obtained in accordance with the processing presented in a schematic fashion in drawing. One notes a narrowing of the distillation range and the best result obtained in the test in which the petroleum was irradiated for 30 minutes at 260° C. (T-20).

TABLE 3

| Simulated | | | | | | |
|---|---|---|---|---|---|---|
| Distillation | | | | | | |
| (% Mass) | PIE | 10% | 25% | 50% | 75% | 90% |
| BC | 97° C. | 243° C. | 345° C. | 471° C. | 610° C. | 714° C. |
| Petroleum | | | | | | |
| T-20 | 114° C. | 228° C. | 319° C. | 450° C. | 581° C. | 684° C. |
| T-29 | 132° C. | 235° C. | 329° C. | 458° C. | 599° C. | 706° C. |
| T-50 | 108° C. | 241° C. | 324° C. | 440° C. | 575° C. | 695° C. |

The process of this invention may be operated in at least three different ways, as presented in the drawing: the first type of the invention process is a batch regimen one, the second type of the invention process is a continuous or semi-continuous reactor, in an stirred flask with a load residence time period dependent on the flow and severity desired, and the third type of the invention process is carried out in a fixed bed continuous reactor.

Below an example of this invention performed in accordance with the process described in the drawing.

The results obtained according to this procedure representative of the invention in all its forms are shown in Tables 1, 2 and 3.

To exemplify one of the preferred forms of performing the invention, experiments were carried out using a lab microwave oven at a frequency of 2.45 GHz and a maximum power of 1000 W, operating in a continuous or pulsed mode and equipped with programmable control devices and a thermocouple and fiber optic temperature sensor to measure temperatures.

The reaction system used comprises a 3-mouth glass flask coated in a microwave (MW) transparent thermal insulator known as kaolin (aluminum-silicate), equipped with mechanical stirring from the well to the temperature sensor via fiber optics then from the condenser to the water chilled flush back maintained outside the microwave cavity.

The operating conditions used to process the petroleum were the normal power of the 200 W, 300 W and 1000 W microwave oven and continuous and pulsed microwave oven operating mode. The absorbent used was a spent HDT sulfided catalyst, in a catalyst-to-oil ration of 0.3.

The initial load temperature was equal to 25° C. The final nominal temperature of the product between 230° C. and 300° C. and pressure equal to atmospheric. The reactionary system is equipped with mechanical stirring and one of the outputs of the reactor was hooked up to a water-chilled reflux condenser.

In this example, in the pulsed operating method of the source of the microwave oven, the nominal power is distributed over time in constant pulses of 1000 W. The frequency of pulses in this equipment is constant at 35 pulses/min. equivalent to 0.58 cycles or 1.7 s/cycle. For an average power of 200 W applied to a system pulsed with 1000 W each pulse lasts 0.34 seconds and powered off intervals of 1.37 seconds.

The load of hydrocarbons assessed in this example was petroleum from the Campos Basin (BC) off the coast of Rio de Janeiro, Brazil and some of its properties are presented in Tables 1, 2 and 3.

The catalysts chosen for this study were hydro refining catalysts, HDR, alumina supported, after being used in an industrial unit or pilot plant (PP). These catalysts, NiMo or CoMo type, with molybdenum sulfate as an active phase, also have high activity a microwave absorbers. With the use of these catalysts the aim was to conjugate in a synergic and localized form in the same active sites, the remaining catalytic activity during the active phase of the molybdenum sulfate with its high capacity to absorb microwaves.

In addition to this, we intend to save on inputs by using spent catalyst as well as putting these spent catalysts removed from hydrotreatment works to new use.

It was noted that hydrotreatment (HDT) catalysts recently removed from units or stored free of contact with the atmosphere interact more effectively with microwaves. These catalysts have a synergic effect between their catalytically active sites and their capacity to absorb microwaves. This synergy, associated with a local temperature higher than the average temperature of the reaction medium, creates a nanoreactor in which the reactions observed occur.

An accentuated reduction in TAN was observed with the increase in microwave power applied to the reaction medium. Greater reduction in total acidity was noted with the application of microwaves in the reaction medium in a pulsed form. The pulsed application is particularly interesting when used with the abovementioned forms of unit in the semi-continuous and continuous microwave reactor with a fixed hydrotreatment catalyst bed, in which the load remains interacting with the microwaves for a short time interval.

The pulsed MW source may add energy to the system in a more efficient way, generating a significant temperature gradient specifically between the active site and the load, hence configuring a nanoreactor. The interval between the microwave pulses may provide a reaction time under ideal conditions after which the new pulse of microwaves supplies more energy, resulting in an accentuated difference in local temperature, creating conditions for new reactions.

In tests carried out, the reduction in total acidity and increase in API GRAVITY were obtained at average temperatures of the reaction medium ranging from 200° C. to 300° C. In the case of the continuous bed process, the increase in average temperature of the load is granted by the spatial velocity and power of the microwaves chosen for the process, without the need as verified, for the load to be heated up to temperatures over 300° C.

In the conditions studied, results indicate that it is possible to reduce total acidity to an acceptable level in commercial terms, adjusting the processing conditions used. Deactivation of the catalyst under the conditions used in the example was not observed.

Under the action of microwaves, mitigation of density and naphthenic acidity occurred at temperatures of the order of 250° C., in other words, lower than those necessary when using conventional thermal heating which is of the order of 300° C.

Table 2 presents a comparison of the results of the specification of the total acidity number (TAN) and the naphthenic acidity number (NAN) of oil from the Campos Basin and a number of typical samples of processed oil after microwave irradiation. A strong reduction in NAN, the naphthenic acidity number in the irradiated load, was observed. The amount supplied by the NAN is directly associated with naphthenic acidity, whilst the TAN refers to the total acidity of the sample.

The value of the naphthenic acidity number of crude petroleum from the Campos Basin was reduced by up to 90% when processed in the presence of spent hydrotreatment (HDT) catalyst under MW irradiation.

An accentuated increase in several fractions of the lighter compounds in the petroleum treated after MW processing was observed. The reduction of the heavy fractions present in the petroleum is proven by the improved physical properties of the petroleum and its API GRAVITY after MW processing.

Spent HDR catalysts can be reused as inputs for this process as long as preserved as far as possible from reoxidation caused by atmospheric exposure. The type and degree of sulfiding of the catalyst significantly influences the heating rate and acidity of the load after treatment.

As will be understood from the foregoing, unlike the process of PI 0503793-0, for example, the process of the present application operates at relatively low temperature (25° C. to 300° C.) and pressure. The range of operation in this process in a microwave oven allows a “scale up” without the characteristic difficulties of industrial processes under high pressure and temperature. For example, the foregoing description describes an improved process focused on the processing of crude oils or oils mixtures in a microwave oven in the presence of spent hydrotreating catalyst. In this case the process operates under relatively low temperature and pressure, without addition of other gases, in continuous or batch reactors, fixed bed reactors, fluidized or mud, improving the oil by reducing at the same time naphthenic acidity and density, i.e., the increase in degrees API.

It must remain clear however that the examples above do not limit the invention. Specialists in the field may envisage other applications of the process and configurations of the invention without straying from the inventive concept described.

What is claimed is:

1. A process for simultaneously reducing naphthenic acidity and increasing API GRAVITY of petroleum and its fractions, comprising:
(a) directing a current of petroleum with a total acidity of 1 mg KOH/g or higher and an API GRAVITY of 22 or lower to a microwave system comprising a microwave petroleum enrichment unit (MTU) containing a microwave absorbent material;
(b) irradiating the flow of petroleum in the microwave unit (MTU) with microwaves in the presence of the microwave-absorbing material to conduct thermal and/or catalytic cracking of organic acids present in the flow of petroleum or mixture of hydrocarbons to obtain an irradiated current;
(c) adjusting the temperature of the irradiated current flowing from the microwave unit (MTU) via thermal exchange with one or more other currents that require pre-heating;
(d) adjusting the pressure of the microwave system so that after microwave irradiation the irradiated current is at the pressure of a system following the microwave system;
(e) removing continually or in batches the irradiated current for subsequent processing in conventional units of a petroleum refining process; and
(f) disposing of the microwave absorbent material using a method employed at conventional refining units.

2. The process according to claim 1, wherein the current of petroleum is selected from the group consisting of petroleum, heavy petroleum, extra-heavy petroleum, mixtures of oils and fractions of hydrocarbons.

3. The process according to claim 1, wherein the current of petroleum comprises a mixture of one or more of petroleum, heavy petroleum, extra-heavy petroleum oils and/or fractions of hydrocarbons.

4. The process according to claim 1, wherein the current of petroleum comprises crude oil, heavy crude oil and/or oil mixtures and their fractions.

5. The process according to claim 1, wherein the surface of the microwave absorbent material comprises active microwave absorbent sites.

6. The process according to claim 1, wherein the microwave absorbent material comprises a catalyst with an active phase comprised of transition or lanthanide metals in the form of oxides or sulfides.

7. The process according to claim 1, wherein the microwave absorbent material comprises nanotubes and/or nanofibers.

8. The process according to claim 1, wherein the process is employed in onboard units, vessels or in conventional petroleum production or refining units.

9. The process according to claim 1, wherein microwave irradiation of the current of petroleum or mixture of hydrocarbons takes place in a stirred reactor in suspension or slurry.

10. The process according to claim 1, wherein the current of petroleum has a total acidity index of from 1 mg KOH/g to 12 mg KOH/g of oil.

11. The process according to claim 1, wherein the process occurs at temperatures of from 25° C. to 300° C.

12. The process according to claim 1, wherein the process occurs at temperatures of 30° C. to 260° C.

13. The process according to claim 1, wherein the special velocity of the current of petroleum is from 0.25 h⁻¹ to 10 h⁻¹.

14. The process according to claim 1, wherein the mass ratio of the microwave absorbent material/current of hydrocarbons is from 0.05 to 1.

15. The process according to claim 1, wherein the microwave absorbent material comprises a catalyst, and the catalyst is selected from hydrotreatment catalysts, spent hydrotreatment catalysts, compounds containing carbon nanofibers and nanotubes, coking fines, tailings from spent catalysts of FCC units, and tailings from spent catalysts of hydrotreatment units.

16. The process according to claim 1, wherein the system following the microwave system is a storage tank, a desalting unit or an atmospheric distillation unit.

17. The process according to claim 6, wherein the catalyst comprises NiMo or CoMo supported on alumina.

18. The process according to claim 6, wherein the catalyst is a previously used catalyst.

19. The process according to claim 1, wherein the microwave absorbent material comprises spent hydrotreatment catalyst.

20. The process according to claim 1, wherein the current of petroleum has a total acidity index of 1.5 mg KOH/g to 10 mg KOH/g of oil.

21. The process according to claim 15, wherein the catalyst is microwave transparent.

22. A process for treating petroleum with microwaves, comprising:
directing a flow of petroleum to a microwave unit containing a microwave absorbent material; and
irradiating the flow of petroleum in the microwave unit with microwaves to cause a simultaneous reduction in naphthenic acidity and increase in API GRAVITY of the flow of petroleum to obtain an irradiated petroleum,
wherein the microwave absorbent material comprises a spent hydrotreatment catalyst.
